(19) United States
(12) Patent Application Publication
(10) Pub. No.: US 2006/0129294 A1
(43) Pub. Date: Jun. 15, 2006

(54) Method for synchronising a steering wheel and steered wheels of a motor vehicle

(76) Inventors: Martin Moser, STUTTGART (DE); Reinhold Schneckenburger, Rutesheim (DE)

Correspondence Address: FASSE PATENT ATTORNEYS, P.A., P.O. BOX 726, HAMPDEN, ME, 04444-0726, US

(21) Appl. No.: 10/543,021

(22) PCT Filed: Dec. 1, 2003
(86) PCT No.: PCT/EP03/13482

§ 371 Date: Oct. 3, 2005

(30) Foreign Application Priority Data
Jan. 22, 2003 (DE) 103 02 559.6

(51) Int. Cl. B62D 5/00

(52) U.S. Cl. 701/41; 180/402

(57) ABSTRACT

The invention relates to a method and a device for synchronizing the position (LH) of the steering handle and the steering angle (LH) which has been set at the steered vehicle wheels. By means of a control device it is possible to set a relationship function or steering characteristic curve (21, 22, 23) between the steering handle position (LH) and the steering angle (LW). After the control device has been activated, the instantaneous handle position (LH) and the instantaneous steering angle (LW) are compared taking into account the instantaneously set relationship function, and in the case of a deviation (S) in position a relative adjustment is carried out in order to reduce the deviation (S) in position between the handle position (LH) and the steering angle (LW).

The invention relates to a method for synchronizing a steering handle and steered vehicle wheels, in particular in the case of a motor vehicle, according to the preamble of claim 1. In addition, the invention relates to a device which is particularly suitable for the method.

Steering systems with a variable relationship function between the position of the steering wheel and the steering angle which has been set at the steered vehicle wheels are affected.

For example, DE 196 01 826 A1 presents a steering system in which a steering gear component which controls the steered vehicle wheels is connected mechanically via a variable ratio gear unit both to a steering wheel and to an automatically controlled electric motor. Accordingly, a change in steering angle of the steered wheels is determined in each case by the superimposition of the change in the position of the steering wheel and the change in position of the electric motor. In principle any relationship function between the handle position and steering angle can then be set by means of a control device which is assigned to the electric motor.

Similar conditions apply in steering systems which operate according to the “steer-by-wire” concept. Such a steering system is described, for example, in DE 100 21 903 A1. In said document, a steering wheel activates a steering angle setpoint value transmitter. A steering angle actual value transmitter and a, for example, electric, actuating motor which is provided for adjusting steering are assigned to the steered vehicle wheels, said actuating motor being controlled by a closed-loop control device as a function of a setpoint value/actual value comparison of the steering angle. As a result, the steering angle of the steered vehicle wheels therefore follows the predefined steering angle of the steering wheel.

If the steering system is faulty, in particular if the power supply is interrupted or switched off, according to DE 100 21 903 A1 a steering column which can be disconnected by means of a clutch is provided between the steering wheel and the steered vehicle wheels, with the clutch being opened during the normal steering mode so that the relationship function between the steering angle which is set at the steered vehicle wheels and the angle of rotation of the steering wheel during normal operation is determined solely by the closed-loop control device.

In such steering systems, the steering wheel can be activated even if the open-loop or closed-loop control device is not operating, if the engine of the vehicle is switched off and/or if the electrical power supply of the vehicle has failed. However, in such a case the relationship function between the steering wheel angle and the steering angle of the steered vehicle wheels is not given in accordance with the steering characteristic curve stored in the open-loop or closed-loop control device but rather there is a mechanical coupling of the steering handle and steered vehicle wheels to a mechanically predefined relationship function. In the case of DE 196 01 826 A1 this is the relationship function of the positive coupling which is present between the steering wheel and the steered vehicle wheels when the electric motor is deactivated. In the case of DE 190 21 903 A1 this is the relationship function of the positive coupling which is brought about between the steering wheel and steered vehicle wheels when the clutch is closed.

If the abovementioned positive coupling is effective at a time at which the steered vehicle wheels assume a steering angle which is different from the straight-ahead position, and the steering handle accordingly assumes a position which is different from the normal position, the correlation between the steered vehicle wheels and the steering handle which is mentioned at the beginning then generally no longer occurs since the relationship function between the position of the handle and the steering angle is different when the positive coupling is active than during normal operation of the steering system. This can lead to a situation in which the normal position of the steering handle no longer coincides with the straight-ahead position of the steered vehicle wheels when the positive coupling is maintained between the steering handle and steered vehicle wheels.

Even if the position of the handle is changed when the control device is deactivated, and if a normal driving mode with actuated control device is subsequently resumed, the correlation between the position of the handle and the steering angle is eliminated. This is due to the relationship function between the position of the handle and the steering angle which is changed in the normal operating mode in comparison with the relationship function given by the steering mechanism when the control device is deactivated.

The object of the invention is to permit, with a steering system of the type mentioned at the beginning, automatic synchronization of the position of the steering handle and the steering angle which has been set at the steered vehicle wheels.

This object is achieved according to the invention by means of the characterizing features of patent claims 1 and 12.

The invention is based on the general idea of performing a possibly necessary or desirable synchronization of the steering handle and steered vehicle wheels after the control device has been activated. This can either be activation after a failure or activation by the electric power supply being switched on again by the driver, for example by means of the ignition. In this activated state, the control device can detect a deviation in position and if appropriate perform a relative adjustment. This relevant adjustment leads to a situation in which the position of the handle and the steering angle correspond to one another taking into account the instantaneously valid relationship function.

Advantageous developments emerge from the dependent patent claims.

It is advantageous if the relative adjustment takes place only if an interrogation criterion is fulfilled after the or during the activation of the control device. The interrogation criterion may be, for example, a driving state variable of the vehicle or a variable describing an operator control activity of the driver. It is basically also possible to perform this relative adjustment after the vehicle has started with the vehicle stationary. However, a driver who does not yet know the steering system or does not known it in such a situation, could be surprised. The driver could then feel that the steering system is no longer following him. Moreover, dangers which arise when careless maintenance or repair work is carried out can be reduced. For example, a person could reach into the movement area of the steered vehicle wheels or place his head there and be trapped by the relative adjustment if at the same time another person switches on the ignition. Since the relative adjustment does not take place until the other interrogation criterion has been fulfilled, this danger is ruled out.

It is possible to provide here that, in particular in the case of a vehicle longitudinal velocity which is lower than a predefinable velocity threshold value, the relative adjustment is to be carried out only while the steering handle (8) is being moved manually by the driver. This measure ensures that the synchronization is carried out by relative adjustment only when the driver is carrying out steering activities and in particular when low longitudinal velocities of the vehicle are present (for example less than 5 km/h) or the vehicle is stationary. The driver can cope with relative adjustments very satisfactorily if he carries out steering activities himself. In this context he must always make slight corrections, but this is hardly perceived during the steering process so that he always has the sensation that the steering system of the vehicle is reacting to his steering activity and following him. Since large steering angle changes in the steered vehicle wheels and corresponding large deflection movements of the steering handle are often necessary directly after a vehicle starts in order to maneuver the vehicle out of a car park onto the carriageway, the synchronization may be carried out in a way which is virtually unnoticed by the driver and completely at a low velocity.

It is also expedient if the relative adjustment takes place in an incremental cyclical fashion, in particular in the case of a vehicle longitudinal velocity which is higher than a predefinable velocity threshold value, and one adjustment step is carried out per adjustment cycle until the deviation in position corresponds to approximately zero. Cyclically carrying out adjustment steps provides the possibility of carrying out the relative adjustment in a way which is adapted to the driving state of the vehicle and the operator control activity of the driver.

In this context, the reduction in the deviation in position per adjustment cycle can be limited to, or defined as, a predefined percentage of the respective current deviation in position, as a result of which deviation in position approaches zero asymptotically. It has been found in trials that such a reduction in deviation in position which has a profile similar to an e function is very pleasant for the driver.

In order to reduce the deviation in position in a time period which is acceptable to the driver, a predefinition is expediently made of an adjustment time period after whose expiry the deviation in position must have reached a value which in absolute terms is less than or equal to a deviation threshold value, which may be approximately zero.

So that the driver has sufficient time to accordingly adjust the position of the handle during the relative adjustment there is advantageously provision for the relative adjustment to take place with an adjustment velocity at the steered vehicle wheels which is predefined or limited to a maximum value. This means that the gradient of the adjustment path which is covered during the relative adjustment is limited or predefined to a fixed value. The driver can then calmly correct the position of the handle so that the desired course of the vehicle is restored. The adjustment speed at the steered vehicle wheels may be, for example, between 0.1 and 1.0° per second. This results, in accordance with the currently set relationship function, in the handle speed with which the driver has to adjust or reposition the steering handle in order to hold his course.

In a further advantageous embodiment of the method there is provision in the case of a vehicle longitudinal velocity which is less than a predefinable velocity threshold value for the relative adjustment to take place only if the direction of a change in the handle position which is carried out manually by the driver corresponds to the direction in which the relative adjustment at the steered vehicle wheels is to take place. A relative adjustment at the steered vehicle wheels to the right is thus carried out only if the driver moves the steering handle in the direction corresponding to a deflection of the wheel to the right, that is to say if, for example, he turns the steering handle to the right, and this applies correspondingly to the relative adjustment to the left.

The deviation in position can be determined in such a way that after the control device (13) has been activated the setpoint position of the steering handle (8) which corresponds to the instantaneous steering angle for the instantaneously set steering transmission ratio is determined, wherein the deviation in position results from the difference between the instantaneous handle position and the setpoint handle position.

The relative adjustment may be carried out as a function of parameters. In particular, the adjustment velocity may depend on one or more parameters which describe the current vehicle movement dynamic state or some other vehicle state. Possible parameters are, for example: a manual force which is effective at the steering handle, the instantaneous deflection of the steering handle out of its normal position corresponding to the straight-ahead position on the steered vehicle wheels, the instantaneous deflection of the steered vehicle wheels out of their straight-ahead position, the absolute value of the deviation in position, a variable which characterizes the lateral dynamics or longitudinal dynamics of the vehicle (for example the longitudinal velocity of the vehicle) and/or the time.

Moreover, with respect to preferred features of the invention reference is to be made to the claims and to the subsequent description of the drawing which describes in more detail particularly preferred embodiments of the invention, and protection is claimed not only for the feature combinations which are described expressly but also for in theory any desired combinations of the described features. In the drawing:

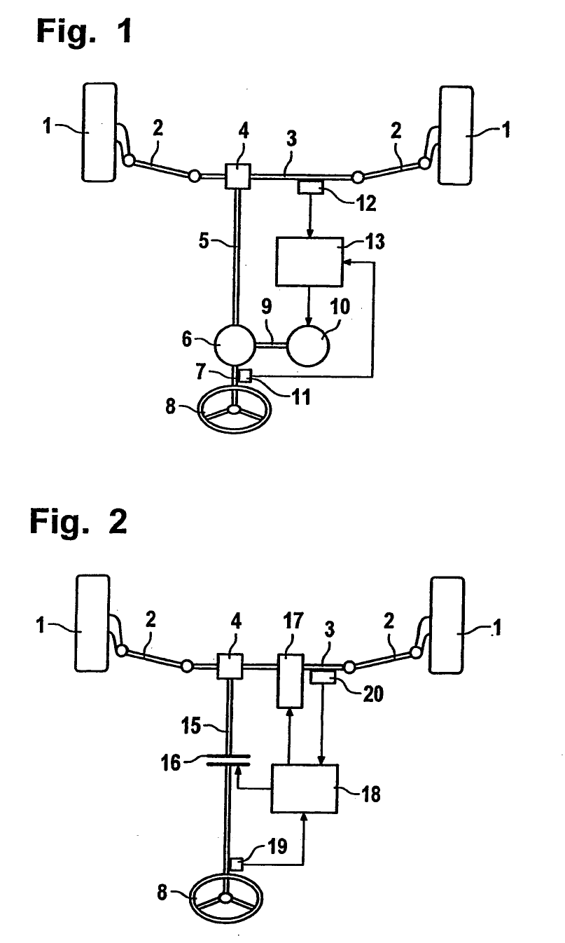

FIG. 1 shows an embodiment of a steering system in which the steered vehicle wheels are mechanically connected to a steering wheel and to a self-locking electric motor via a variable ratio gear unit,

FIG. 2 shows an exemplary embodiment of a steering system which operates according to the steer-by-wire concept, and

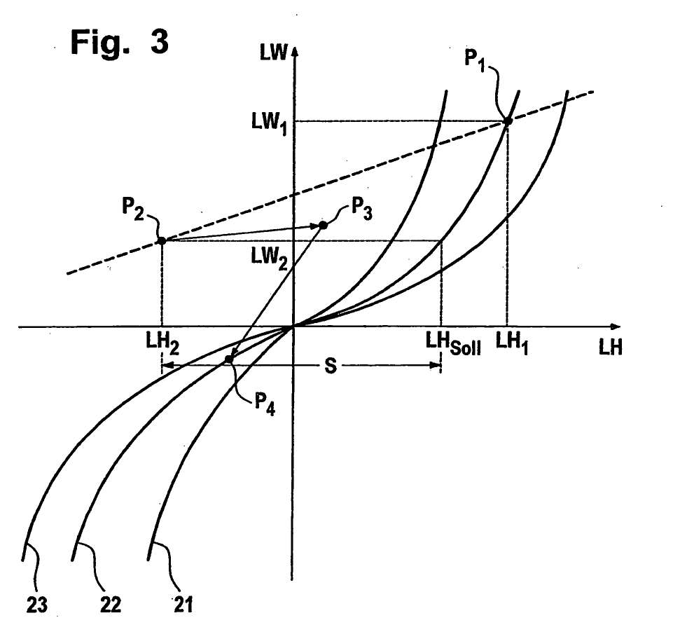

FIG. 3 is a diagram illustrating various steering characteristic curves which each specify a relationship function between the position of the steering handle and the steering angle of the steered vehicle wheels, with possible synchronization measures being also represented by way of example.

According to FIG. 1, a motor vehicle (which is otherwise not illustrated in more detail) has steerable front wheels 1 which are connected to one another via track rods 2 with a connecting rod 3 to form a common steering activation system.

The connecting rod 3 is forcibly mechanically coupled via a gear mechanism 4 to a steering shaft 5 which has a drive connection, on the one hand, via a variable ratio gear unit 6 to a steering wheel shaft 7 on which a steering handle which is embodied as a steering wheel 8 is arranged so as to be fixed in terms of rotation and, on the other hand, via a shaft 9 to a self-locking electric motor 10. The superimposition of rotational movements of the steering wheel shaft 7 and of the shaft 9 therefore determines the rotational movement of the steering shaft 5. Accordingly, the rotational movements of the two shafts 7 and 9 are superimposed, with the rotational movement of the steering shaft 5 resulting from this superimposition.

The position LH of the steering wheel 8 is sensed by a handle sensor. In the exemplary embodiment illustrated according to FIG. 1, the steering wheel shaft 7 or the steering wheel 8 interacts with a rotational angle transmitter 11 which forms the handle sensor and which senses the rotational adjustment of the steering wheel 8 or steering wheel shaft 7. Alternatively or additionally an instantaneous sensor could also be used as a handle sensor.

A steering angle transmitter is provided for sensing the steering angle which is instantaneously set at the steered vehicle wheels. For this purpose, the connecting rod 3 interacts with a position transducer 12 which senses the displacement in the connecting rod 3 and thus the average steering angle LW of the front wheels 1. It goes without saying that instead of or in addition to the position transducer 12 it would also be possible to use, for example, angle sensors or other suitable sensors.

The rotational angle transmitter 11 and position transducer 12 are connected to corresponding inputs of an electronic control device 13 which actuates the electric motor 10 or a driver circuit (not illustrated) of this motor 10 which is in turn connected fixedly in terms of rotation to the shaft 9 and drives the latter accordingly. As stated above, the rotational movement of the steering wheel shaft 7 is superimposed on the rotational movement of the shaft 9 to form the rotational movement of the steering shaft 5 which is then converted into a change in steering angle by means of the gear mechanism 4, the connecting rod 3 and the track rod 2.

In the example in FIG. 2, the connecting rod 3 is connected via the gear mechanism 4 to a steering shaft 15 which can be disconnected and coupled in terms of movement by means of a clutch 16 so that the steering wheel 8 which is arranged on the steering shaft 15 so as to be fixed in terms of rotation to the end of the steering shaft 15 which is remote from the transmission is mechanically connected in terms of movement to the connecting rod 3, and accordingly to the steerable front wheels 1, only when the clutch 16 is closed, and is mechanically decoupled in terms of movement from the steerable front wheels when the clutch 16 is open. The connecting rod 3 is connected in terms of drive to a, for example, electric, self-locking-free actuating motor 17. Said actuating motor 17, or its driver circuit (not illustrated), is controlled by means of an electronic closed-loop control device 18 which is assigned at the input end a handle sensor, which is assigned to the steering wheel 8 or the steering-wheel-end part of the steering shaft 15 and is embodied as a rotational angle transmitter 19, and to a displacement sensor 20 for sensing the displacement of the connecting rod 3 and correspondingly of the central steering angle LW of the front wheels. As is described in conjunction with FIG. 1, in this exemplary embodiment also the handle sensor could alternatively or additionally have a torque sensor, and an angle sensor could additionally or alternatively be used to measure the steering angle LW.

Moreover, the closed-loop control device 18 is connected at the output end to the clutch 16 or to an actuating motor (not illustrated) of the clutch 16 which is held open by the closed-loop control device 18 in the normal steering operating mode.

In the normal steering operating mode, the closed-loop control device 18 carries out a setpoint/actual value comparison for the steering angle LW. The steering angle setpoint value is determined in the closed-loop control device 18 by means of the handle position LH sensed by the rotational angle transmitter 19. The rotational angle actual value is measured by the displacement transducer 20. The closed-loop control device 18 controls the actuating motor 17 as a function of the difference between the steering angle setpoint value and steering angle actual value so that as a result the steering adjustment of the steerable front wheels 1 follows the predefined values of the steering wheel 8.

The closed-loop control device 18 can, in determining the steering angle setpoint value, take into account parameters such as adjustment values which can be set by the driver or, for example, parameters describing the vehicle movement dynamic state of the vehicle such as the longitudinal velocity of the vehicle. As a result, various functions for the relationship between the handle position LH and the steering angle LW—which can also be referred to as steering characteristic curves—can be set as a function of parameters. It is also conceivable in this context for the driver to be able to select in each case a relationship function as a current relationship function from a plurality of predefined relationship functions or steering characteristic curves.

When there are faults which adversely affect the steering system in the normal operating mode and when the electric power supply of the closed-loop control device 18 is switched off, for example after the vehicle has been parked, the clutch 16 closes so that the steerable front wheels 1 are controlled in a conventional mechanical fashion by means of the steering shaft 15 using the steering wheel 8, with the self-locking-free actuating motor 17 also being moved. When the clutch is closed, another relationship function from that during the normal operating mode of the steering system is then given.

The synchronization of the handle position LH with the position of the steered vehicle wheels 1 will be explained below in more detail with reference to FIG. 3. In the diagram in FIG. 3, the steering angle LW is plotted at the steered vehicle wheels by means of the steering wheel angle LH. By way of example relationship functions or steering characteristic curves 21 to 23 which can be set in the normal operating mode of the steering systems described with respect to FIGS. 1 and 2 are illustrated.

As is shown by way of example by the steering characteristic curves 21 to 23, the straight-ahead position of the front wheels 1, i.e. LW=0, is always assumed precisely when the steering wheel 8 assumes its central position in which LH=0.

It is possible to change or switch over from one steering characteristic curve to another steering characteristic curve, for example from the first steering characteristic curve 21 to the second steering characteristic curve 22, even while the vehicle is traveling. In this context, the first steering characteristic curve 21 is displaced incrementally toward the second steering characteristic curve 22 until the relationship function given by the second steering characteristic curve 22 has been reached. In the switching over process, a plurality of steering characteristic curves between the first and second steering characteristic curve are, as it were, successively activated in order to accustom the driver slowly to the changing steering behavior of the vehicle.

It will now be assumed that the current handle position LH has the value LH₁ and the second steering characteristic curve 22 is currently active so that the steering angle LW₁ is set in the normal operating mode. Consequently, the first point P₁ on the second steering characteristic curve 22 is obtained. It will also be assumed that when the position of the steering is unchanged the vehicle is shut down so that the electric power supply is switched off and that in this shut-down state the steering handle is moved so that the handle position LH changes.

When the vehicle is deactivated or the engine of the vehicle is switched off and/or the electric on-board power system is switched off the steering automatically goes into a special operating mode corresponding to a “fall back level”. In the case of a steering system as in FIG. 1 this is equivalent to the electric motor 10 remaining deactivated irrespective of the rotational travel of the steering wheel 8. In the case of a steering system in FIG. 2, the clutch 16 is closed so that the steering wheel 8 is forcibly mechanically coupled to the steered front wheels 1.

However, when the electric power supply is switched off a special operating characteristic curve 24 which is different from the second steering characteristic curve 22, is predefined by the mechanical configuration of the steering system and constitutes, for example a straight line but in a modification of this it may in principle also have other profiles. The special operating characteristic curve 24 is illustrated by dashed lines in FIG. 3.

By way of the rotation of the steering wheel 8 with the electronic power supply switched off starting from that position of the steering wheel 8 and of the steered vehicle wheels 1 which is defined by the first point P₁ an assignment function is obtained according to the special operating characteristic curve 24 which passes through the first point P₁. As a result, the synchronization between the handle position LH and steering angle LW is cancelled because the special operating characteristic curve does not pass through the coordinate jump 0. At a steering angle LW of zero, the steering wheel angle is unequal to zero, and vice versa. Correspondingly, during operation at the fall back level there is no synchronization between the steering wheel 8 and steered front wheels 1, i.e. the steered front wheels 1 assume their straight-ahead position when the steering wheel 8 is not located in the central position or have a position which deviates from the straight-ahead position if the steering wheel 8 is in its central position.

It will be assumed that when the power supply is switched off the second point P₂ on the special operating characteristic curve 24 will have been reached before the steering system can return to its normal operating mode. If the electric power supply is, for example, switched on again by starting the vehicle, the relationship function which was set last and which corresponds to the second steering characteristic curve 22 is activated or set. However, the second point P₂ does not lie on the steering characteristic curve 22 so that a relative adjustment between the steering wheel 8 and steered vehicle wheels 1 has to take place for synchronization purposes.

After the open-loop or closed-loop control device has been activated by switching on the electric power supply, the deviation S in position is determined. At first, a setpoint handle position LH_{Sol1} of the steering handle which corresponds to the instantaneous steering angle LW₂ with the instantaneously set relationship function according to the steering characteristic curve 22 is determined, with the deviation S in position being obtained from the difference between the instantaneous handle position LH₂ and the setpoint handle position LH_{Sol1}. The sign of the deviation S in position indicates the direction in which the steered vehicle wheels 1 are to be moved during the relative adjustment.

For example there is now provision here for the necessary relative adjustments for synchronization purposes to be carried out only if an interrogation criterion is fulfilled.

Firstly, the longitudinal velocity of the vehicle serves as the interrogation criterion with the present embodiment of the method. If the longitudinal velocity of the vehicle is larger in absolute terms than a predefined velocity threshold value, which may be, for example, between 0.5 and 5 km/h, the relative adjustment takes place cyclically. In each adjustment cycle, an adjustment step is carried out so that the deviation S in position is reduced after each adjustment step.

The absolute value of the adjustment step which is carried out in each adjustment cycle is obtained from a permanently predefined percentage of the absolute value of the deviation S in position which is then current in this adjustment cycle. The absolute value of the adjustment steps accordingly decreases in each adjustment cycle. However, the synchronization speed, that is to say the gradient of the relative adjustment, is limited to a maximum value in order to avoid rapidly decreasing relative adjustment movements which the driver cannot compensate without difficulty by correcting the handle position LH. The relative adjustment then takes place very slowly, for example with synchronization speeds between 0.1 and 1.0° per second at the steered vehicle wheels.

In one modified embodiment variant it is also possible to predefine an adjustment time period after whose expiry the deviation S in position must be less than a predefined deviation threshold value by an absolute value, or equal to said predefined deviation threshold value, in order to avoid long deviations in position being present. The deviation threshold value may be, for example, approximately zero.

In the case of a longitudinal velocity of the vehicle which is lower than the predefined velocity threshold value, the relative adjustment takes place only while the steering handle 8 is being moved manually by the driver. Furthermore only a relative adjustment is performed if the direction of the change in the position of the handle corresponds to the direction in which the relative adjustment is to be carried out. This means that a relative adjustment at the steered vehicle wheels 1 to the right occurs only when the steering wheel is rotated to the right. This applies correspondingly to a relative adjustment to the left.

This case of a longitudinal velocity of the vehicle which lies below the velocity threshold value is assumed in FIG. 3.

Starting from the second point P₂, the steering angle LW increases much less in the direction of the relatively large handle position values LH than it actually should according to the currently set relationship function in accordance with the second steering characteristic curve 22 (arrow 25 in FIG. 3). A slight increase in the steering angle LW is carried out in order to impart to the driver a functionally capable change in steering angle which follows its steering wheel movement.

At the third point P₃, the driver switches over the direction of rotation of the steering wheel 8 so that starting from this position the relationship between the handle position LH and steering angle LW according to arrow 27 is given. Here, the steering angle LW is reduced to a greater degree by the superimposed relative adjustment than is predefined by the change in the handle position and the second steering characteristic curve 22.

Finally, the arrow 27 strikes the second steering characteristic curve 22 at the fourth point P₄. Starting from this time, the deviation S in position is reduced to zero and the relationship function between the steering angle LW and the handle position LH correspond again to the profile of the second steering characteristic curve 22.

The gradient of the arrows 25 and 27 may be changeable as a function of parameters provided that the open-loop control device 13 of the steering system according to FIG. 1 or the closed-loop control device 18 of the steering system according to FIG. 2 receives, from a corresponding sensor system, data relating to the respective parameters. For example, the deviation with which the steering angle LW is synchronized again with the handle position LH by the superimposed relative adjustment is calculated as a function of the longitudinal velocity of the vehicle. Alternatively it would also be possible to take into account other variables which describe the longitudinal or transverse dynamics of the vehicle, such as the longitudinal acceleration or the transverse acceleration. The current handle position LH, the current steering angle LW or other parameters which describe the state of the vehicle can also be taken into account.

1-12. (canceled)

13. A method for synchronizing the position (LH) of the steering handle and the steering angle (LW) which has been set at the steered vehicle wheels (1) for steering with a relationship function which can be set between the handle position (LH) and the steering angle (LW) by means of an open-loop or closed-loop control device (13; 18), wherein after the activation of the open-loop or closed-loop control device (13; 18) which follows nonoperation of the open-loop or closed-loop control device (13; 18) the instantaneous handle position (LH) and the instantaneous steering angle (LW) are compared taking into account the instantaneously set relationship function, and in the case of a deviation (S) in position a relative adjustment is carried out in order to reduce the deviation (S) in position between the handle position (LH) and the steering angle (LW), characterized in that the relative adjustment takes place only if after or during the activation of the open-loop or closed-loop control device (13; 18), an interrogation criterion is fulfilled in addition to the deviation (S) in position.

14. The method as claimed in claim 13, characterized in that, in particular in the case of a vehicle longitudinal velocity which is lower than a predefinable velocity threshold value, the relative adjustment takes place only while the steering handle (8) is being moved manually by the driver.

15. The method as claimed in claim 13, characterized in that the relative adjustment takes place in an incremental cyclical fashion, in particular in the case of a vehicle longitudinal velocity which is higher than a predefinable velocity threshold value, and one adjustment step is carried out per adjustment cycle until the deviation (S) in position is approximately zero.

16. The method as claimed in claim 15, characterized in that the reduction in the deviation (S) in position per adjustment cycle is limited to, or defined as, a predefined percentage of the respective current deviation (S) in position.

17. The method as claimed in claim 13, characterized by the definition of an adjustment time period after whose expiry the deviation (S) in position has to have reached a value which in absolute terms is less than or equal to a predefined deviation threshold value.

18. Method as claimed in claim 13, characterized in that the relative adjustment takes place with a synchronization speed at the steered vehicle wheels (1) which is predefined or limited to a maximum value.

19. The method as claimed in claim 13, characterized in that in the case of a vehicle longitudinal velocity which is less than a predefinable velocity threshold value, the relative adjustment takes place only if the direction of the change in the handle position corresponds to the direction in which the relative adjustment is to take place.

20. The method as claimed in claim 13, characterized in that after the control device (13) has been activated the setpoint position (LH_{Sol1}) of the steering wheel (8) which corresponds to the instantaneous steering angle (LW) for the instantaneously set steering transmission ratio is determined, wherein the deviation (S) in position results from the difference between the instantaneous handle position (LHᵢₛₜ) and the setpoint handle position (LH_{Sol1}).

21. The method as claimed in claim 13, characterized in that the relative adjustment takes place as a function of parameters.

22. The method as claimed in claim 21, characterized in that the relative adjustment takes place as a function of a manual force which is effective at the steering wheel (8) and/or of the instantaneous deflection of the steering wheel (8) out of its normal position corresponding to the straight-ahead position of the steered vehicle wheels (1) and/or of the instantaneous deflection of the steered vehicle wheels (1) out of their straight-ahead position and/or of the absolute value of the deviation (S) in position and/or of a variable which characterizes the lateral dynamics or longitudinal dynamics of the vehicle and/or of the longitudinal velocity of the vehicle and/or of time.

23. A device for carrying out the method as claimed in claim 13, having means (11; 19) for determining the position (LH) of a steering wheel (8) of a vehicle, having means (12; 20) for determining the steering angle (LW) of the steered vehicle wheels (1) and having an open-loop or closed-loop control device (13; 18) for setting the steering angle (LW) as a function of the position (LH) of the steering wheel (8) and a relationship function which can be set between the handle position (LH) and the steering angle (LW), wherein after the open-loop or closed-loop control device (13; 18) has been activated following nonoperation it compares the instantaneous handle position (LH) and the instantaneous steering angle (LW) taking into account the instantaneously set relationship function between the handle position (LH) and steering angle (LW), and in the case of a deviation (S) in position it carries out a relative adjustment in order to reduce the deviation (S) in position between the handle position (LH) and the steering angle (LW), characterized in that the relative adjustment takes place only if, after or during the activation of the open-loop or closed-loop control device (13; 18), an interrogation criterion is fulfilled in addition to the deviation (S) in position.
